(19) United States
(12) Patent Application Publication
(10) Pub. No.: US 2008/0034965 A1
(43) Pub. Date: Feb. 14, 2008

(54) Apparatus for dehydrator and compressor combination skid and method of operation

(75) Inventors: Swen Theil, Airdrie (CA); Rick Bower, Calgary (CA)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Leader Energy Services Ltd., Calgary (CA)

(21) Appl. No.: 11/604,017

(22) Filed: Nov. 22, 2006

(30) Foreign Application Priority Data
Aug. 11, 2006 (CA) 2,555,905

(51) Int. Cl. B01D 53/26

(52) U.S. Cl. 95/42; 95/161

(57) ABSTRACT

A combined compressor and dehydrator apparatus including a gas compressor unit with an exhaust through which exhaust gas is expelled from said gas compressor unit; a glycol dehydrator unit with a glycol reboiler; a means of transferring heat from said exhaust of said gas compressor unit to said glycol reboiler of said glycol dehydrator unit; and a skid; wherein said gas compressor unit, said glycol dehydrator unit and said means of transferring heat are fixedly attached to said skid.

### FIELD OF THE INVENTION

The present invention relates generally to heat transfer systems and more specifically to the transfer of heat generated by a compressor motor for use in a dehydrator to remove Water dissolved in a carrier fluid such as glycol.

### BACKGROUND

Gas compressors are commonly used to pressurize natural gas in order to facilitate the gas's movement through pipelines and other facilities.

Glycol dehydration is a process that removes naturally occurring water, usually in the form of vapour, from natural gas, thereby preventing hydrate formation in and corrosion of gas pipelines. A glycol dehydration unit exposes natural gas to glycol. When natural gas comes in contact with glycol, the glycol removes water vapour from the natural gas. However, the glycol itself eventually becomes saturated with water and ineffective at removing water vapour from natural gas. At this point, the glycol and water mixture is moved to a glycol reboiler forming part of a glycol dehydration unit. The glycol reboiler separates the water from the glycol by raising the temperature of the mixture to a level that will cause the water to evaporate but is below the boiling point of glycol. After the water has been evaporated, the glycol may again be used to remove water vapour from natural gas.

Conventional glycol dehydration units are gas-fired to generate the necessary heat to flash off the water dissolved in the glycol. There are several drawbacks associated with these units: safety issues; the cost of the fuel they consume; the negative environmental impact caused by their burning of fuel. With respect to safety issues, a conventional glycol dehydration unit cannot even be placed on the same skid as a gas compressor unit because of the explosion hazards. This greatly increases the cost of installation and makes it expensive to transport or move the units from place to place.

### SUMMARY

The present invention is directed toward a combination gas compressor unit and a glycol dehydrator unit wherein exhaust heat from the compressor's prime mover is transferred and used in the glycol dehydrator unit. One objective of the present invention is to provide an easy to manufacture and mobile apparatus that combines a gas compressor and a glycol dehydrator on one skid. Another objective of the present invention is to provide an apparatus that transfers the heat generated by a gas compressor unit to the glycol reboiler of the glycol dehydrator. Another objective of the present invention is to provide a glycol reboiler that does not burn fuel to achieve its requisite temperature. Yet another objective of the present invention is to provide a glycol dehydrator that is safer than fuel-fired dehydrators.

The stated objectives are accomplished by a novel apparatus wherein a gas compressor and a glycol dehydrator are manufactured together on a single skid. A closed fluid circuit connects a heat exchanger in the exhaust of the compressor unit with a heat exchanger in the glycol reboiler of the glycol dehydrator. A heat-transfer fluid is pumped through the closed circuit. Heat is transferred to the heat-transfer fluid as it passes through the heat exchanger in the exhaust of the compressor's prime mover. As the heat-transfer fluid flows through the heat exchanger in the reboiler, heat is transferred to the glycol and water mixture in the glycol reboiler to boil off the water content. The flow and/or temperature of the heat transfer fluid is regulated to maintain the requisite temperature in the glycol reboiler.

According to the present invention then there is provided a combined compressor and dehydrator apparatus comprising a gas compressor unit, said gas compressor unit comprising at least an exhaust through which exhaust gas is expelled from said gas compressor unit; a glycol dehydrator unit, said dehydrator unit comprising at least a glycol reboiler; a means of transferring heat from said exhaust of said gas compressor unit to said glycol reboiler of said glycol dehydrator unit; and a skid; wherein said gas compressor unit, said glycol dehydrator unit and said means of transferring heat are fixedly attached to said skid.

### BRIEF DESCRIPTION OF THE DRAWINGS

Preferred embodiments of the present invention will now be described in greater detail and will be better understood when read in conjunction with the following drawings in which:

FIG. 1 is a schematical flow diagram of the of the combined compressor unit and dehydrator unit apparatus according to an embodiment of the invention;

FIG. 2 is a diagrammatic view of the exhaust gas heat exchanger forming part of the apparatus of FIG. 1; and

FIG. 3 is a schematical flow diagram of a modified apparatus comprising another aspect of the present invention.

### DETAILED DESCRIPTION OF THE PREFERRED EMBODIMENT

The construction and operation of both gas compressors and glycol dehydration units is well known in the art and a detailed description of how they function and are used is therefore omitted from the present description. There are many commercially available units in the market today and the skilled technician will be familiar with the selection of units having a size, capacity and throughput appropriate to any particular installation. The present invention is intended to be adapted for use in most if not all such installations either as original equipment, a retrofit or as a temporary replacement.

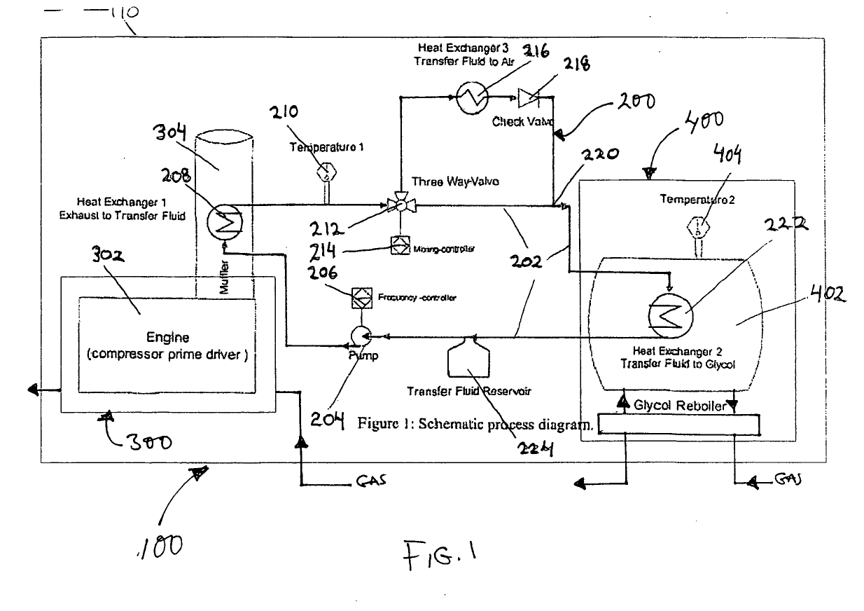

Referring to FIG. 1, the combined dehydration and compressor skid 100 of the present invention generally comprises a mounting skid 110, a closed loop fluid circuit 200 for a heat transfer fluid (also called “hot oil”), a gas compressor unit 300, and a glycol dehydrator unit 400. Compressor unit 300, glycol dehydrator 400 and fluid circuit 200 are mounted onto a skid 110 which can be a transportable or permanently installed platform for these major components of the system.

Fluid circuit 200 comprises piping or tubing 202, a circulation pump 204, a pump controller 206, a first heat exchanger 208 in the exhaust stream from the compressor's prime mover 302, a first temperature gauge 210, a three way-valve 212, a three way-valve controller 214, a third heat exchanger 216, a one way check valve 218, a three-way connector 220, a second heat exchanger 222 disposed within the glycol reboiler 402 of glycol dehydrator 400 and a heat-transfer fluid reservoir 224.

To complete closed loop fluid circuit 200, tubing 202 connects pump 204 to first heat exchanger 208; first heat exchanger to three-way valve 212; three-way valve to third heat exchanger 216 and to three-way connector 220; third heat exchanger 216 to three-way connector 220; three-way connector to second heat exchanger 222, second heat exchanger 222 to heat-transfer fluid reservoir 224 and heat-transfer fluid reservoir back to pump 204 to close the loop. Third heat exchanger 216 is in contact with ambient air for shedding excess heat in the transfer fluid to atmosphere. First temperature gauge 210 is disposed in fluid piping 202 between first heat exchanger 208 and three-way valve 212 to monitor the temperature of the transfer fluid leaving first heat exchanger. The check valve 218, disposed in fluid piping 202 between third heat exchanger 216 and three-way connector 220, permits one-way flow only of heat-transfer fluid from third heat exchanger 216 to three-way connector 220.

Gas compressor 300 includes prime mover 302 and an exhaust manifold 304 that will typically also include a muffler for noise abatement. Prime mover 302 is a commercially available internal combustion engine or gas turbine manufactured by companies such as Caterpillar Corporation that can generate a thousand or more horsepower and produce exhaust stack temperatures that can exceed 400° C. First heat exchanger 208 is disposed in manifold 304 so that exhaust gas produced by compressor motor 302 heats the transfer fluid being pumped through first heat exchanger 208.

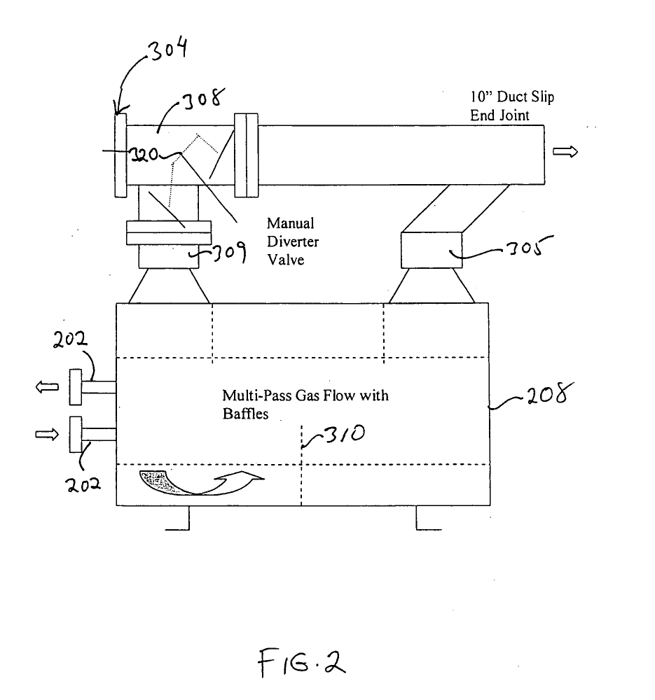

Reference is made to FIG. 2, wherein like numerals have been used to identify like elements, which illustrates an exemplary arrangement of heat exchanger 208 relative to manifold 304. Exhaust gas from motor 302 flows into a duct 308 and through a diverter 309 into heat exchanger 208. Inside the exchanger are a series of baffles 310 to cause the gas to circulate inside the exchanger and around the coils or loops (not shown) of tubing 202 for the heat transfer fluid. The cooled exhaust exits exchanger 208 through outlet 305 and back into duct 308 for eventual discharge to the atmosphere. Diverter 309 preferably includes a diverter valve 320, which can be opened and closed manually, which is operable to direct the flow of gas into the heat exchanger by simultaneously closing duct 308 and opening the diverter, or closing the diverter and opening the duct. Valve 320 can also be partially opened to split the flow of exhaust gas for additional control over the temperature of the transfer fluid flowing through exchanger 208.

As mentioned above, glycol dehydrator 400 includes a glycol reboiler 402. Glycol reboiler 402 includes its own temperature gauge 404 to monitor the temperature of the glycol being heated inside the reboiler by second heat exchanger 222. As is known in the art, glycol dehydrator unit 400 circulates hydrated glycol to glycol reboiler 402 where the water is boiled off and the escaping vapour is exhausted to the atmosphere.

A description of the operation of compressor skid 100 according to an embodiment of the present invention follows.

Fluid circuit 200 is filled with a heat-transfer fluid such as Dowtherm™ RP or Q to approximately 300° C. Pump 204 circulates the heat-transfer fluid around fluid circuit 200 at a preferred rate of 9.7 gallons per minute or approximately 2125 kg per hour. Other rates are contemplated as well. The heat-transfer fluid flows initially from pump 204, through piping 202 to first heat exchanger 208 where its heated by exhaust gas from manifold 304. Next, the heat-transfer fluid flows to three-way valve 212. Three-way valve 212 is operable to permit heat-transfer fluid to flow either to third heat exchanger 216 or to second heat exchanger 222 or both. Heat-transfer fluid directed by three-way valve 212 to third heat exchanger 216 is cooled by ambient air as it passes through the exchanger and then flows through check-valve 218 and on to second heat exchanger 222. The heat-transfer fluid flowing through second heat exchanger 222 heats the glycol in glycol reboiler 402 to temperatures ideally in the range of 390° to 405° F. Other temperatures are contemplated depending upon the particular application. From second heat exchanger 222, the heat-transfer fluid then flows to heat-transfer fluid reservoir 224 and back to pump 204, completing fluid circuit 200.

First temperature gauge 210 monitors the temperature of heat-transfer fluid after it has passed through first heat exchanger 208. Second temperature gauge 404 monitors the temperature of glycol in the glycol reboiler 402.

Compressor skid 100 maintains the temperature in glycol reboiler 402 within a preset range: greater than the boiling point of water but less than the boiling point of glycol. The temperature in glycol reboiler 402 is regulated by up to three mechanisms. First, pump controller 206 controls the rate of flow of heat-transfer fluid through fluid circuit 200 by adjusting the speed of pump 204. Second, the three-way valve controller 214 operates three-way valve 212 to direct the heat-transfer fluid either directly to second heat exchanger 222 in whole or in part or to third heat exchanger 216, where the heat-transfer fluid will be cooled prior to its arrival at second heat exchanger 222. Third, the amount of exhaust gas flowing through first exchanger 208 can be regulated by diverter valve 320.

The temperature at first temperature gauge 210 and second temperature gauge 404 is analyzed to determine if the heat-transfer fluid is too hot or too cold to maintain the preset temperature range in glycol reboiler 402. If the heat-transfer fluid is too hot or too cold, one or more of the three temperature regulation mechanisms described above is used to adjust the temperature and/or flow rate of the heat-transfer fluid appropriately. This process can of course be automated using conventional thermostatic controls or computerized system as will be known in the art.

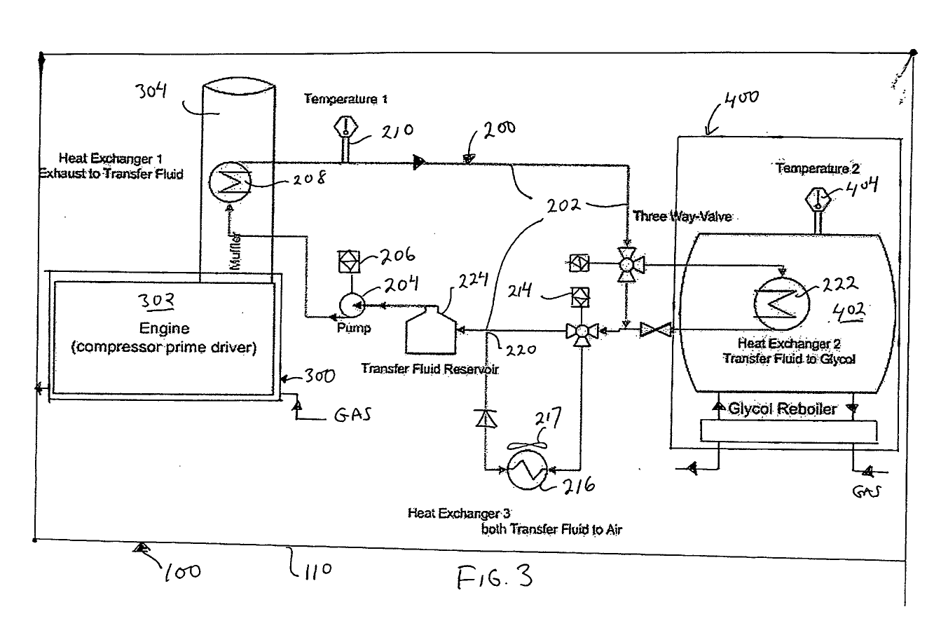

Reference is made to FIG. 3 which is a more detailed flow diagram of the present system wherein like numerals have been used to denote like elements. Notable differences between this system and that shown in FIG. 1 include placement of heat exchanger 216, including a fan 217, between heat exchanger 222 and reservoir 224 instead of between heat exchanger 208 and exchanger 222 for improved thermal efficiency. Also shown are additional controls, by-passes, filters, re-cycle separators, sensors, gauges, valves and inlets for heat from possible additional external sources that can be added to the heat transfer fluid.

The above-described embodiments of the present invention are meant to be illustrative of preferred embodiments and are not intended to limit the scope of the present invention. Various modifications, which would be readily apparent to one skilled in the art, are intended to be within the scope of the present invention. The only limitations to the scope of the present invention are set forth in the following claims appended hereto.

The embodiments of the invention in which an exclusive property or privilege is claimed are defined as follows:

1. An apparatus comprising:
a gas compressor unit, said gas compressor unit comprising at least an exhaust through which exhaust gas is expelled from said gas compressor unit;
a glycol dehydrator unit, said dehydrator unit comprising at least a glycol reboiler;
a means of transferring heat from said exhaust of said gas compressor unit to said glycol reboiler of said glycol dehydrator unit; and
a skid;
wherein said gas compressor unit, said glycol dehydrator unit and said means of transferring heat are fixedly attached to said skid.

2. The apparatus of claim 1 wherein said means of transferring heat from said exhaust of said gas compressor unit to said glycol reboiler of said glycol dehydrator unit comprise a closed fluid circuit comprising:
a heat-transfer fluid, said heat-transfer fluid filling said closed fluid circuit;
a first heat exchanger, said first heat exchanger fixedly disposed in said exhaust of said gas compressor unit;
a second heat exchanger, said second heat exchanger fixedly disposed in said glycol reboiler of said glycol dehydrator unit; and
a pumping means;
wherein said heat-transfer fluid is pumped by said pumping means through said closed fluid circuit and said heat-transfer fluid flows through first heat exchanger and through second heat exchanger.

3. The apparatus of claim 2 wherein said closed fluid circuit further comprises means of regulating the temperature of said heat-transfer fluid.

4. The apparatus of claim 3 wherein said means of regulating the temperature of said heat-transfer fluid comprise:
a parallel fluid circuit that connects to said closed fluid circuit between said first heat exchanger and said second heat exchanger, said parallel fluid circuit comprising a third heat exchanger, said third heat exchanger exposed to ambient air;
a three-way valve operable to direct flow or to block flow of said heat-transfer fluid through said parallel circuit; and
a three-way valve control means;
wherein said three-way valve control means operate said three-way valve.

5. The apparatus of claim 4 wherein said means of regulating the temperature of said heat-transfer fluid further comprise:
a pump control means;
wherein said pump control means control the pump frequency of said pumping means.

6. The apparatus of claim 2 further comprising means of monitoring the temperature of said heat-transfer fluid and the temperature of said glycol reboiler.

7. A method of transferring heat between an exhaust of a gas compressor unit and a glycol reboiler of a glycol dehydrator unit comprising the steps of:
pumping a heat-transfer fluid through a closed fluid circuit, said closed fluid circuit including a first heat exchanger in said exhaust of a gas compressor unit and a second heat exchanger in said glycol reboiler of a glycol dehydrator unit; and
maintaining a preset temperature range in said glycol reboiler.

8. The method of claim 7 wherein said step of maintaining a preset temperature range in said glycol reboiler comprises the steps of:
monitoring the temperature of said heat-transfer fluid after it leaves said first heat exchanger and before it enters said second heat exchanger;
monitoring the temperature of said glycol reboiler;
analysing said monitored temperature of said heat-transfer fluid and said monitored temperature of said glycol reboiler to make a determination if said heat-transfer fluid should be heated or cooled to maintain said preset temperature; and
regulating the temperature of said heat-transfer fluid according to said determination using temperature regulation means.

9. The method of claim 8 wherein said temperature regulation means comprise:
directing or blocking flow of said heat-transfer fluid to a third heat exchanger which is exposed to ambient air; and
reducing or increasing flow of said heat-transfer fluid through said closed fluid circuit.

10. The method of claim 9 wherein said preset temperature range is the temperature range between the boiling point of water and the boiling point of glycol.
